(19) United States
(12) Patent Application Publication
(10) Pub. No.: US 2009/0239767 A1
(43) Pub. Date: Sep. 24, 2009

(54) BIOMOLECULE DETECTION REAGENT AND METHOD FOR DETECTING BIOMOLECULE USING REAGENT

(75) Inventors: Hideki Hoshino, Tokyo (JP); Naoko Furusawa, Tokyo (JP); Hisatake Okada, Tokyo (JP)

Correspondence Address: LUCAS & MERCANTI, LLP, 475 PARK AVENUE SOUTH, 15TH FLOOR, NEW YORK, NY, 10016, US

(73) Assignee: Konica Minolta Medical & Graphic, Inc., Tokyo (JP)

(21) Appl. No.: 12/441,509

(22) PCT Filed: Sep. 5, 2007
(86) PCT No.: PCT/JP2007/067281

§ 371 Date: Mar. 16, 2009

(30) Foreign Application Priority Data
Sep. 19, 2006 (JP) 2006-252453

(51) Int. Cl. C40B 30/10; G01N 21/64

(52) U.S. Cl. 506/12; 436/172; 977/904

(57) ABSTRACT

A biomolecule detection reagent comprising semiconductor nanoparticles and magnetic nanoparticles, incorporated in a bead comprising an inorganic compound or an organic polymer, and a surface of the beads is modified with a biomolecule detection molecule.

### TECHNICAL FIELD

The present invention relates to a biomolecule detection reagent utilizing semiconductor nanoparticles and magnetic nanoparticles, and to a method for detecting a biomolecule using the reagent.

### BACKGROUND TECHNOLOGIES

With advances of molecular biology, a variety of mechanism in which biological body works has become clear, and efforts to elucidate a disease or a cancer of the brain or other organs at the molecular level have been made. As one of the efforts, a method for determining functions of the biological body and their abnormalities as fluorescence images, a so-called bio-imaging method, has been progressing.

In this field, heretofore, a method of using a biosubstance labeling agent as a means for detecting a biomolecule, in which a molecule labeling substance was bonded to a marker substance, has been studied. However, marker substances such as organic fluorescence dyes, which had been previously used in the aforesaid method, exhibited disadvantages such as severe deterioration and short life upon exposure to ultraviolet rays and also resulted in lowered emission efficiency and insufficient sensitivity.

For example, a method, in which fluorescent micro beads are employed in an immunoassay utilizing an antigen-antibody reaction, has been known (for example, refer to Patent Document 1). In this method, beads having a size of micron order, which become specific reaction sites, were dyed in an organic medium, whereby reading or identification of the beads were carried out via a fluorescence microscope or a flow site meter. However, it was not easy to identify the beads, and particularly, it was difficult to correctly and easily identify many beads of from several teas to several tens thousand kinds.

A method for measuring an antibody has also been known, in which a rapid and convenient separation of bonded substances from unreacted products can be readily achieved by employing fluorescent labeled particles and magnetic particles. However, since organic fluorescent dyes are employed, the method exhibits problems such as complicated operations and insufficient sensitivity (for example, refer to Patent Document 2).

In the meantime, the recent progress in nanotechnology suggests a possibility that nanoparticles can be used for detection, diagnosis, perception, and other uses. Further, recently, nanoparticle complexes, which interact with a biological system, receive broad attention in fields of biology and medicine. These complexes have been considered to be promising as a new intravascular probe for both perception (for example, imaging) and a therapeutic purpose (for example, drug delivery).

In general, a semiconductor material of nanometer size exhibiting a quantum confinement effect is called a “quantum dot”. Such a quantum dot is a tiny mass of a cluster of semiconductor atoms of from several hundred to several thousand with a size of within about a dozen or so nanometers, but when the quantum dot absorbs light from an excited source and reaches an energy excited state, it releases energy corresponding to an energy band gap of the quantum dot. Therefore, an energy band gap can be controlled by controlling the size or material composition of the quantum dot. As a result, energy in various wavelength bands can be utilized.

For that reason, a method employing a semiconductor nanoparticle as the above marker substance has been widely watched. For example, a biosubstance labeling agent, in which polymers exhibiting a polar functional group are absorbed or bonded physically and/or chemically to the surface of semiconductor nanoparticles, has been studied (for example, refer to Patent Document 3). Also a biosubstance labeling agent, in which organic molecules are bonded to the surface of Si/SiO₂ type semiconductor nanoparticles, has been studied (for example, refer to Patent Document 4).

For example, Patent Document 5 discloses a technology by which biopolymers such as DNAs or proteins are readily detected utilizing semiconductor nanoparticles exhibiting different excited wavelengths and fluorescent emissions depending on different particle sizes.

However, a method, in which the above biosubstance labeling agent was employed in an immunoassay method based on a principle of an antigen-antibody reaction, exhibits problems such that detection sensitivity is still insufficient, or separation of unreacted products is complex even if detection sensitivity is sufficient. Therefore, a development of a technology has been demanded, in which both detection and separation can be achieved with one biosubstance detection agent. Further a system has been desired, in which voluminous amounts of information such as genetic diagnosis can be labeled at a time.
Patent Document 1: unexamined Japanese Patent Application Publication No. (hereinafter, referred to as JP-A) 2004-226234
Patent Document 2: JP-A 7-151756
Patent Document 3: JP-A 2003-329686
Patent Document 4: JP-A 2005-172429
Patent Document 5: JP-A 2003-322654

### DISCLOSURE OF THE INVENTION

### Issues To Be Solved By The Invention

The present invention has been achieved in consideration of such problems, and it is an object of the invention to provide a biomolecule detection reagent which has high detection sensitivity and allows to easily separate unreacted products of antigen-antibody reaction in an immunoassay utilizing an antigen-antibody reaction, and a method for detecting a biomolecule using the reagent.

### Measures To Solve The Issues

The above issues of the present invention can be resolved by the measures below.

Item 1. A biomolecule detection reagent comprising semiconductor nanoparticles and magnetic nanoparticles, incorporated in a bead comprising an inorganic compound or an organic polymer, and a surface of the beads is modified with a biomolecule detection molecule.

Item 2. The biomolecule detection reagent described in Item 1 above, wherein the semiconductor nanoparticles can emit fluorescent light having different wavelengths depending on a different particle size.

Item 3. The biomolecule detection reagent described in Item 1 above, wherein the semiconductor nanoparticles are comprised of at least two kinds of semiconductor nanoparticles, being able to emit fluorescent light having different wavelength.

Item 4. The biomolecule detection reagent described in Item 1 above, wherein the semiconductor nanoparticles can emit fluorescent light having different wavelengths depending on a different particle size, and incorporate at least two kinds of semiconductor nanoparticles.

Item 5. A method for detecting a biomolecule comprising the step of: employing a biomolecule detection reagent described in any one of items 1-4 above.

Item 6. The method for detecting a biomolecule described in Item 5 above, wherein a semiconductor nanoparticle complex, a surface being modified with a biomolecule-detection molecule having a different particle size from that of the semiconductor nanoparticle incorporated into a bead, is further employed in combination with the biomolecule detection reagent.

Item 7. The method for detecting a biomolecule comprising the step of: employing the biomolecule detection reagent described in Item 4 above, wherein the method is carried out on a microarray.

### Effects Of The Invention

According to the above means of the present invention, there can be provided a biomolecule detection reagent exhibiting high detection sensitivity and allowing to easily separate unreacted products of antigen-antibody reaction in an immunoassay utilizing an antigen-antibody reaction, and a method for detecting a biomolecule using the reagent.

### DESCRIPTION OF THE PREFERRED EMBODIMENTS

The biomolecule detection reagent of the present invention is characterized in that the reagent is composed of beads comprising an inorganic compound or an organic polymer, and incorporating semiconductor nanoparticles and magnetic nanoparticles, and the surface of the beads is modified with a biomolecule-detection molecule.

The “beads comprising an inorganic compound or an organic polymer, and incorporating semiconductor nanoparticles and magnetic nanoparticles” may be represented by beads having a core/shell structure whose core mainly incorporates semiconductor nanoparticles and magnetic nanoparticles, or beads incorporating semiconductor nanoparticles and magnetic nanoparticles as a dispersion into a matrix comprising an inorganic compound or an organic polymer.

The term “bead” denotes a particulate incorporating semiconductor nanoparticles and magnetic nanoparticles. The particle size of the aforesaid bead is preferably from 10 nm to 10 μm, and more preferably from 50 to 500 nm.

Hereinafter, the present invention and its constitutional elements are described in detail.

### (Inorganic Compound)

Inorganic compounds employed in the present invention are not particularly limited as long as they may secure the stability of semiconductor nanoparticles and magnetic nanoparticles. In particular, in case where a rare-earth metal is employed as the nanoparticle material, materials which can prevent coordination of water molecules are preferred. Specific examples thereof include metal oxides such as glass, silica, and yttrium oxide; metal phosphates such as calcium phosphate and strontium phosphate; and metal sulfides such as zinc sulfide. Among them, glass is preferable in terms of light absorption properties.

### (Organic Polymer)

The organic polymers employed in the present invention are not particularly limited, but examples thereof include condensation products and polymers, both of which are composed of at least one of compounds such as an (un)saturated hydrocarbon, an aromatic hydrocarbon, an (un)saturated fatty acid, an aromatic carboxylic acid, an (un)saturated ketone, an aromatic ketone, an (un)saturated alcohol, an aromatic alcohol, an (un)saturated amine, an aromatic amine, an (un)saturated thiol, and an organosilicon compound. The term “(un)saturated” means both saturated and unsaturated. Examples of the above condensation products and polymers include polyolefins such as polyethylene and polybutadiene; polyethers such as polyethylene glycol, and polypropylene glycol; polystyrene, poly(meth)acrylic acid, poly(meth)acrylic acid ester, polyvinylalcohol, polyvinylester, phenol resins, melamine resins, allyl resins, furan resins, polyesters, epoxy resins, silicon resins, polyimide resins, polyurethanes, Teflon (trade mark), acrylonitrile/styrene resins, styrene/butadiene resins, vinyl resins, polyamide resins, polycarbonates, polyacetals, polyether sulfones, polyphenylene oxides, sugar, starch, celluloses, and polypeptides. These organic compounds may be used individually or in combination of at least two thereof.

### (Semiconductor Nanoparticle)

<Forming Material of Semiconductor Nanoparticle>

The semiconductor nanoparticles of the present invention can be formed by employing various semiconductor materials. For example, semiconductor compounds of IV group, II-VI group, or III-V group of periodic table of elements can be employed.

As a semiconductor material, it is preferable to employ a material in which a semiconductor nanoparticle exhibits quantum size effect depending on the particle size leading to emission of desired fluorescent light of different wavelength. Further, an employment of at least two kinds of semiconductor nanoparticles differing in colors of fluorescent light is a preferred embodiment.

Among II-VI group semiconductors, particularly listed are MgS, MgSe, MgSe, MgTe, CaS, CaSe, CaTe, SrS, SrSe, SrTe, BaS, BaSe, BaTe, ZnS, ZnSe, ZnTe, CdS, CdSe, HgS, HgSe, and HgTe.

Among III-V group semiconductors, preferred are GaAs, GaN, GaP, GaSb, InGaAs, InP, InN, InSb, InAs, AlAs, AlP, AlSb, and AlS.

Among VI group semiconductors, Ge, Pb, and Si are particularly suitable.

In the present invention, it is preferable that the semiconductor nanoparticle exhibits a core/shell structure. In such a case, it is preferable that the semiconductor nanoparticle exhibits a so-called core/shell structure which is constituted with a core portion comprising a semiconductor nanoparticle and a shell portion which covers the aforesaid core portion, and chemical compositions of the aforesaid core portion and shell portion differ from each other.

The core particle and the shell layer are described below.

### <Core Particle>

Various semiconductor materials can be employed in the core particle. Specific examples thereof include MgS, MgSe, MgTe, CaS, CaSe, CaTe, SrS, SrSe, SrTe, BaS, BaTe, ZnS, ZnSe, ZnTe, CdS, CdSe, CdTe, GaAs, GaP, GaSb, InGaAs, InP, InN, InSb, InAs, AlAs, AlP, AlSb, AlS, PbS, PbSe, Ge, Si, and a mixture of them. In the present invention, semiconductor materials of Si, and CdSe are particularly preferred.

The semiconductor material may contain a very small amount of doping materials such as Ga, if necessary.

The average particle size of the above core portion is preferably from 1 to 10 nm to exhibits the effects of the invention. When the above average particle size is made to be from 1 to 10 nm, labeling and detection of a biomolecule with a small particle size become possible. Further, when the size is made to be from 1 to 5 nm, labeling and dynamic imaging of one biomolecule become sufficiently possible. Therefore, the size of from 1 to 5 nm is particularly preferable.

The average particle size of a core/shell type semiconductor particle, in which a size of a shell portion is added, is preferably from 3 to 50 nm, and more preferably, from 3 to 10 nm.

In the present invention, the term “an average particle size” denotes an accumulative 50% in volume particle size. The measurement thereof is carried out in such a manner that 100 particles, for example, are observed, and the average value is calculated using a particle size distribution value of the 100 particles, which are measured via a commonly used TEM (Transmission Electron Microscope).

### <Shell Layer>

Various semiconductor materials can be employed for the shell. Specific examples include ZnO, ZnS, ZnSe, ZnTe, CdO, CdS, CdSe, CdTe, MgS, MgSe, GaS, GaN, GaP, GaAs, GaSb, InAs, InN, InP, InSb, AlAs, AlN, AlP, AlSb, and a mixture of them.

Preferable materials for the shell layer include semiconductor materials exhibiting higher band gap energy than that of the core of semiconductor nanocrystal particle.

Materials suitable for the shell should have, in addition to higher band gap energy than that of a core of a semiconductor nanocrystal particle, excellent conductivity and valence band offset regarding a core of semiconductor nanoparticle particle. Therefore, it is desirable that the conduction band is higher than that of a core semiconductor nanocrystal particle, and the valence band is lower than that of a core semiconductor nanocrystal. For a core of a semiconductor nanocrystal particle emitting energy in the visible region or in the near infrared region, materials having a band gap energy in the ultraviolet region are usable (for example, Si, Ge, and GaP for visible region, and InP, InN, PbS, and PbSe for infrared region). Specific examples thereof include ZnS, GaN and a magnesium chalcogenide (for example, MgS, MgSe, and MgTe).

For a core of a semiconductor nanocrystal particle emitting energy in the near infrared region, materials having band gap energy in the visible region are also usable.

In the present invention, semiconductor materials of SiO₂ and ZnS are particularly preferred.

The shell layer of the present invention does not necessarily perfectly cover the whole surface of the core particle, as long as the partially exposed core particle does not cause harmful effects.

### <Method for Producing Semiconductor Nanocrystal>

Various commonly known methods can be employed for producing the semiconductor nanoparticles of the present invention.

The production method employing a liquid phase method includes a coprecipitation method as one of precipitation methods, a sol-gel method, a homogeneous precipitation method, and a reduction method. In addition, methods such as a reverse micelle method, and a supercritical hydrothermal synthesis method are also excellent methods for producing nanoparticies (please refer to, for example, JP-A 2002-322468, JP-A 2005-239775, JP-A H10-310770, and JP-A 2000-104058).

As the production method employing a gas phase method, the following methods are employed: (1) a method in which raw materials for semiconductors are evaporated via the first high-temperature plasma generated between electrodes opposing each other, which are then passed through the second high-temperature plasma generated by electrodeless discharge in a reduced pressure atmosphere (please refer to, for example, JP-A 6-279015), (2) a method in which, via electrochemical etching, nanoparticles are separated and removed from an anode composed of raw materials for semiconductors (please refer to, for example, JP-A 2003-515459), and a laser abrasion method (please refer to, for example, Japanese Translation of PCT International Application Publication No. 2004-356163). Further, preferably employed is a method in which raw material gasses are subjected to a gas phase reaction in a reduced pressure state to synthesize powders containing particles.

As the method for producing the semiconductor nanoparticles of the present invention, the production method via the liquid phase method is particularly preferred.

In order to achieve a uniform particle size and intensity of emitted light of the semiconductor nanoparticles of the present invention, the semiconductor nanoparticles exhibiting less lattice defects and high crystallinity are required by optimizing conditions such as purity of the raw materials, concentration at synthesis, synthesis temperature and time, and annealing temperature and time after the particles are formed.

### (Magnetic Nanoparticle)

The magnetic nanoparticle of the present invention is preferably a nanoparticle of from 1 to 50 nm in average particle size exhibiting magnetism. Since the average particle size thereof is 1 nm or more, the nanoparticle can be stably produced, and since it is 50 nm or less, the nanoparticle can capture a target substance by penetrating into a cell even in a case of, for example, targeting a substance in a cell. Further, since the reaction efficiency of the magnetic nanoparticle is high because the surface area is large, it can also quickly capture even a vary small amount of target substance. In view of stability and magnetic responsiveness of the crystal, the average particle size of the magnetic nanoparticle is preferably from 3 to 40 nm, and particularly preferably from 5 to 20 nm.

Such magnetic nanoparticles can be produced according to, for example, a method described in patents such as Japanese Translation of PCT International Application Publication No. 2002-517085. For example, iron oxides or ferrite magnetic nanoparticles can be formed in such a manner that an aqueous solution containing iron(II) compounds, or an aqueous solution containing iron(II) compounds and metal(II) compounds is held under oxidation state which is required for the formation of magnetic oxides, and a pH of the above solution is maintained in the range of 7 or more. The magnetic nanoparticles of the present invention can also be obtained by mixing an aqueous solution containing a metal(II) compound and an aqueous solution containing an iron(III) under an alkaline condition. Further, a method described in Biocatalysis 1991, Vol. 5 pp 61-69 can also be employed.

The preferable magnetic nanoparticle of the present invention may be selected from a group consisting of metal oxides, especially iron oxides and ferrites (Fe, M)₃O₄. In the group, the iron oxides include, in particular, a magnetite, a maghemite, and a mixture thereof. The magnetic nanoparticle may take a core/shell type structure in which the surface and the interior differ in composition. In above formula (Fe, M)₃O₄, M represents a metal ion, which, together with the aforesaid iron ion, can form a magnetic metal oxide. M is typically selected from transition metals, and most preferably includes Zn²⁺, Co²⁺, Mn²⁺, Cu²⁺, Ni²⁺, and Mg²⁺. The molar ratio of M/Fe is determined based on the stoichiometric formulation of the selected ferrite. The metal salts are provided in the form of solid or liquid, and preferably chlorides, bromides, or sulfates. Among them, iron oxides are preferred in view of safety.

In order to form, for example, a magnetite, it is preferable that irons exist in solution in two different oxidation states of Fe²⁺ and Fe³⁺. The existence of the two different oxidation states in solution can be achieved in such a way that a mixture of an iron(II) salt and an iron(III) salt is added in solution, preferably iron(II) salt being added slightly more than the iron(III) salt in a molar amount compared to the targeted composition of a magnetic oxide, or an iron(II) salt and an iron(III) salt are added in solution and, if necessary, a part of Fe²⁺ or Fe³⁺ is converted to other oxidation state preferably by oxidation, or, in some cases, by reduction.

The above magnetic metal oxide is preferably ripened at a temperature of from 30 to 100° C., preferably a temperature in the range of from 50 to 90° C.

The pH value of the solution is required to be 7 or more for causing interaction among various metal ions to form magnetic metal oxides. The pH value is maintained in a targeted range by employing a suitable buffer solution as an aqueous solution when the first metal salt is added, or by adding a base to the solution after the metal ion being converted to a necessary oxidation state. Once a specific pH value, which is in the range of pH of 7 or more, is selected, the pH value is preferably maintained throughout the whole process of preparing magnetic nanoparticles to secure substantially uniform size distribution of the final products.

For the purpose of controlling the particle size of magnetic nanoparticles, a step, in which an additional metal salt is added to the solution, may be arranged. In this case, the step can be carried out in two different operation modes described below. One operation mode is carried out by stepwise increase, which is, hereinafter, referred to as a stepwise operation mode. In this operation mode, each component (which is a metal salt, an oxidizing agent and a base) is successively added to the solution in a predetermined order in several batches, preferably in equal amount for every batch. These steps are repeated necessary times so that the desired nanoparticle size is obtained. The amount to be added each time is such that polymerization of metal ions in the solution (that is, except for on the surface of the particle) can be substantially prevented.

The other mode is a continuous operation mode, in which each component (which is a metal salt, an oxidizing agent and a base) is added continuously to a solution in a predetermined order and at substantially uniform flow rates for each component to prevent polymerization of metal ions at portions of the particle except for the surface thereof. By employing the above stepwise or continuous operation mode, particles exhibiting a narrow size distribution can be formed.

### <Surface Modification of Beads by Detection Molecule>

In case where the surface of the beads of the present invention is hydrophobic, the dispersibility in water of the particles is low to possibly cause problems such as coagulation of the particles if the particles are employed as they are. Therefore, it is preferable that the surface of nanoparticles (or the surface of shells, in case of the semiconductor nanoparticles being a core/shell type) is subjected to hydrophilic treatment.

The methods for hydrophilic treatment include, for example, a method in which a surface modification agent is chemically or physically bonded onto the surface of a particle after oleophilic groups on the surface are removed by pyridine. The surface modification agents, having a carboxyl group or an amino group as a hydrophilic group, are preferably employed, and the specific agents include a mercaptopropionic acid, a mercaptoundecanoic acid, and an aminopropanethiol.

The detection molecules of the present invention are not particularly limited, as long as they are employable for a specific detection of biopolymers, and examples thereof include oligonucletides or polynucleotides such as avidin, streptavidin, biotin, an antigen, an antibody, a DNA and an RNA.

For example, in case where avidin or streptavidin is allowed to be bonded as a detection molecule, the bonds can be formed in such a manner that, by employing an alkylthiol compound having a carboxyl group (hereinafter, also possibly referred to as a thiolcarboxylic acid) as, for example, a substituted alkylthiol, semiconductor nanoparticles with the above carboxyl groups being exposed on the surface, are prepared, and after the above carboxyl groups axe further derivatized by employing, for example, N-hydroxysulfosuccinimide, avidin or streptavidin (available from, for example, Sigma-Aldrich Japan K.K.) are allowed to react with the derivatized carboxyl groups to form the bonds.

In case where biotins are allowed to be bonded as a detection molecule, the bonds can be formed in such a manner that, by employing alkylthiol compounds having amino groups (hereinafter, also possibly referred to as a aminothiol) as, for example, a substituted alkylthiol, semiconductor nanoparticles, with the above amino groups being exposed on the surface, are prepared, and the above amino groups are allowed to react with derivatized biotins such as Biotin-Sulfo-Osu (sulfosuccinimidyl D-biotin)(available from Dojindo Laboratories) to form the bonds.

Any person skilled in the art can appropriately select reaction conditions and reagents suitable for bonding by substituted reactions, according to the kinds of functional groups on the beads and the kinds of targeted detection molecules.

In the present invention, the detection molecules are preferably avidin, streptavidin, or biotin.

### (Method for Detecting BioMolecule)

Detection of a biomolecule such as a biopolymer by employing a biomolecule detection reagent of the present invention can be performed in such a manner that a biomolecule detection reagent of the present invention is added into a sample incorporating, for example, a polynucleotide or a protein, which are previously labeled with a molecule capable of specifically reacting with a detection molecule, and the resulting semiconductor nanoparticles, on which specific bonding has been formed, are isolated, and then the fluorescence thereof is detected. The bonding reaction and the detection can also be performed in solution

The detection may also be performed in a cell containing a biomolecule, and the reaction may also be performed on a microarray such as a DNA chip or a protein chip.

In an example of one embodiment of the present invention, for example, an oligonucleotide immobilized on a DNA chip is hybridized with a biotin-labeled oligonucleotide, after which the presence or absence of the hybridization can be detected by adding thereto the semiconductor nanoparticles bonded with avidin or streptavidin. Depending on the presence or absence of hybridization, it is possible to determine whether or not the targeted gene is present in an intended sample. The term “oligonucleotide” used in the present specification means, but not particularly limited to, a DNA or RNA oligonucleotide having a length of at most of 100 bases, and it may be of natural origin or may be synthesized.

Further, a cDNA immobilized on a DNA chip is hybridized with a biotin-labeled cDNA, after which the presence or absence of hybridization can be detected by adding semiconductor nanoparticles bonded with avidin or streptavidin thereto. Depending on the presence or absence of hybridization, it is possible to determine whether or not the targeted gene is present in an intended sample.

Moreover, an oligonucleotide immobilized on a DNA chip is hybridized with a biotin-labeled cDNA, after which the presence or absence of hybridization can be detected by adding semiconductor nanoparticles bonded with avidin or streptavidin thereto. Depending on the presence or absence of hybridization, it is possible to determine whether or not the targeted gene is present in an intended sample.

In other embodiment, an oligonucleotide immobilized on a DNA chip is hybridized with an avidin- or streptavidin-labeled oligonucleotide, after which the presence or absence of hybridization can be detected by adding semiconductor nanoparticles bonded with avidin thereto. As with the above case, depending on the presence or absence of hybridization, it is possible to determine whether or not the targeted gene is present in an intended sample.

Further, a cDNA immobilized on a DNA chip is hybridized with an avidin- or streptavidin-labeled cDNA, after which the presence or absence of hybridization can be detected by adding semiconductor nanoparticles bonded with a biotin thereto. Depending on the presence or absence of hybridization, it is possible to determine whether or not the targeted gene is present in an intended sample.

Further, an oligonucleotide immobilized on a DNA chip is hybridized with an avidin- or streptavidin-labeled cDNA, after which the presence or absence of hybridization can be detected by adding semiconductor nanoparticles bonded with biotin thereto. Depending on the presence or absence of hybridization, it is possible to determine whether or not the targeted gene is present in an intended sample.

On the other hand, in a case of detecting a protein, for example, a protein immobilized on a protein chip is bonded to a biotin-labeled protein, after which the presence or absence of bonding between the proteins can be detected by adding semiconductor nanoparticles bonded to avidin or streptavidin thereto.

Further, a protein immobilized on a protein chip is bonded to a protein labeled with avidin or streptavidin, after which the presence or absence of bonding between the proteins can be detected by adding semiconductor nanoparticles bonded to biotin thereto.

As a method for detecting the biomolecule of the present invention, preferred is a method of an embodiment in which a semiconductor nanoparticle is bonded to avidin or streptavidin, and a biotin-labeled biomolecule is detected by fluorescence of the aforesaid semiconductor nanoparticle.

In the method of the present invention, a plurality of kinds of biopolymers can be detected by employing a plurality of kinds of semiconductor nanoparticles differing in particle size or chemical composition. If each peak of the fluorescence spectra of the semiconductor nanoparticles employed is distinguishable from each other, a plurality of kinds of biopolymers can be detected at the same time. Two peaks separated by, for example, about 100 nm from each other are sufficiently distinguishable, while depending on the sharpness of the peaks. The detectable range is from 400 nm to 700 nm.

### EXAMPLES

The present invention is described in detail below with reference to examples, but the invention is not limited to them.

The composition of the cleaning solution and the dispersion used in the experiments below is composed of 50 mM of Tris (tris(2-amino-2-(hydroxymethyl)propane-1,3-diole), 0.9% NaCl, and 0.1% Tween 20, and a pH thereof is adjusted to 9.0.

### Comparative Example

An antihuman IgM monoclonal antibody (Medix Biochemica Inc.) was immobilized, employing a carbodiimide via a chemical bonding method, on polystyrene latex incorporating a magnetic substance (Fe₂O₃) (hereinafter, referred to as Mg latex; Rhone-Poulenc S.A.) exhibiting an average particle size of 0.7 μm, after which the particles were stabilized by treating them with bovine serum albumin (BSA) to prepare an Mg latex reagent which were dispersed into a buffer solution at a concentration of 0.05%.

3×10⁻⁴ mol of Eu-NTA (β-naphthoyl trifluoroacetone) compound (prepared by inventers), which is a rare-earth chelate, and 6×10⁻⁴ mol of TOPO (trioctyl phosphine oxide)(Dojin Laboratories) were dissolved into 40 grams of acetone, after which, a suspension of 3 grams of polystyrene latex (JSR Corp.) exhibiting an average particle size of 0.459 μm in 40 ml of water was mixed with the above resulting acetone solution. Then, the Eu chelate was incorporated into the latex particles by removing acetone via an evaporator to prepare Eu-labeled latex (hereinafter referred to as Eu latex).

Hepatitis B virus core antigen (HBcAg)(The Chemo-Sero-Therapeutic Institute) produced by gene recombination by employing a carbodiimide was immobilized to Eu latex via a chemical binding method, after which, it was treated by BSA, and then suspended into a buffer solution at a concentration of 0.003% to prepare a Eu latex reagent. Specificity of 98 negative specimens and 93 positive specimens, whose IgM-anti HBcAG-antigen had been already determined via a RIA method, was investigated.

3 μl of specimen, 300 μl of Tris buffers incorporating BSA, and 40 μl of the above Mg latex reagent were mixed, which mixture was then stirred to carry out an immune response for 5 minutes. Subsequently, the Mg latex in a reaction cell was separated from the reaction solution by employing a magnet, the supernatant thereof was removed, after which, 250 μl of buffers and 40 μl of the above Eu latex reagent were added into the resulting Mg latex and mixed to carry out an immune response for 10 minutes.

A separation and cleaning process was carried out in such a manner that the Mg latex in a reaction cell was separated from a reaction solution by employing a magnet, and the remaining reaction solution was removed, after which, 300 μl of cleaning solution was added. The above process was repeated three times, after which, 300 μl of the final dispersion was added to the separated Mg latex, and then mixed to make dispersion. The intensity of fluorescence of the resulting dispersion was determined.

From an amount of the Eu latex contained in the bonded sample, fluorescence was determined. For the negative specimen in which an amount of antigen is small, higher intensity of fluorescence originated from a bond between the Eu latex and the Mg latex was observed. On the other hand, since the positive specimen has only a small number of bonds between the Eu latex and the Mg latex, lower intensity of fluorescence than that of the negative specimen was observed. However, there was no definite difference in intensity between them, and some tests out of 20 specimen tests carried out did not give a clear decision, indicating low detection accuracy.

### Example 1

Fe₂O₃ magnetic nanoparticles of 10 nm and CdSe semiconductor nanoparticles of 6 nm were mixed in a ratio of 1:1 (by mass), which was then subjected to an emulsion polymerization to synthesize polystyrene latex exhibiting an average particle size of 0.7 μm (hereinafter referred to as composite latex 1).

An antihuman IgM monoclonal antibody (Medix Biochemica Inc.) was immobilized, employing a carbodiimide via a chemical bonding method, on composite latex 1, after which, the particles were stabilized by treating them with bovine serum albumin (BSA) to prepare a composite latex reagent which was dispersed into a buffer solution at a concentration of 0.05%.

3 μl of specimen, 300 μl of Tris buffers incorporating BSA, and 40 μl of the above composite latex reagent were mixed, which mixture was then stirred to carry out an immune response for 5 minutes. Further, semiconductor nanoparticles CdSe of 4.5 nm, on which surface an antihuman IgM monoclonal antibody was immobilized, were added. Then, by carrying out an immune response for 10 minutes, an antigen in the specimen was conjugated to the above semiconductor nanoparticles by a sandwich structure of an antibody. Subsequently, a separation and cleaning process was carried out in such a manner that the composite latex 1 in a reaction cell was separated from a reaction solution by employing a magnet, and the remaining supernatant was removed, after which, 300 μl of cleaning solution was added. The above process was repeated three times, after which, 300 μl of the final dispersion was added to the separated composite of composite 1, and then stirred to make dispersion. After that, the intensity of fluorescence of the resulting dispersion was determined.

Intensity of fluorescence was determined on measuring samples of semiconductor nanoparticles of 6 nm in diameter of composite latex 1 incorporated in the bonded sample and semiconductor nanoparticles of 4.5 nm in diameter of an antigen which sandwiched an antibody. in the semiconductor nanoparticles of 6 nm in diameter, a high intensity of fluorescence was observed for a positive specimen, and a low intensity of fluorescence was observed for a negative specimen. Further, fluorescence determination of the semiconductor nanoparticles of 4.5 nm in diameter made a positive detection possible with a high accuracy. Even in the above detections repeated 20 times, clear distinction between the positive and the negative was made to prove high reproducibility accuracy.

### Example 2

Fe₂O₃ magnetic nanoparticles of 10 nm in diameter, CdSe semiconductor nanoparticles of 6 nm in diameter, and CdSe semiconductor nanoparticles of 6 nm in diameter were mixed in a ratio of 1:0.5:0.5 (by mass), which was then subjected to an emulsion polymerization to synthesize polystyrene latex exhibiting an average particle size of 0.7 μm (hereinafter referred to as composite latex 2).

An antihuman IgM monoclonal antibody (Medix Biochemica Inc.) was immobilized on composite latex 2 employing a carbodiimide via a chemical bonding method. After that, the particles were stabilized by treating them with bovine serum albumin (BSA) to prepare composite latex reagent 2 which was dispersed into a buffer solution at a concentration of 0.05%.

3 μl of specimen, 300 μl of Tris buffers incorporating BSA, and 20 μl of each of the above composite latex reagents 1 and 2 were mixed, which mixture was then stirred to carry out an immune response for 5 minutes. Further, semiconductor nanoparticles CdSe of 4.5 nm in diameter, on which surface an antihuman IgM monoclonal antibody was immobilized, were added. Then, by carrying out an immune response for 10 minutes, an antigen in the specimen was conjugated to the above semiconductor nanoparticles by a sandwich structure of an antibody. Subsequently, a separation and cleaning process was carried out in such a manner that the composite latex in a reaction cell was separated from a reaction solution by employing a magnet, and the remaining supernatant was removed, after which, 300 μl of cleaning solution was added. The above process was repeated three times, after which, 300 μl of the final dispersion was added to the separated composite latex, and then stirred to make dispersion. After that, the intensity of fluorescence of the resulting dispersion was determined in a similar manner to Example 1.

As measuring samples of the remaining amounts of composite latexes 1 and 2 incorporated in the bonded sample, intensity of fluorescence of each of semiconductor nanoparticles of 3 nm in diameter and of 6 nm in diameter was determined. A high intensity of fluorescence was observed for a positive specimen, and a low intensity of fluorescence was observed for a negative specimen. Further, by detecting light emission of particles of 4.5 nm in diameter, the detection with higher accuracy became possible.

### Example 3

As measuring samples of the remaining amounts of composite glass beads 1 and 2, which are incorporated in the bonded samples, intensity of fluorescence of each sample was determined in a similar manner to the above operations described in example 2 except that composite glass beads, in which the polystyrene latex was changed to glass, was employed.

It was confirmed that, by employing the biomolecule detection reagent of the present invention, operations such as dissolving and reacting an organic fluorescent dye are not required and detection can be carried out in simpler and easier way compared to those of comparative example. In addition, high emission intensity and high specificity can be obtained, whereby detection can be achieved with high accuracy.

1. A biomolecule detection reagent comprising semiconductor nanoparticles and magnetic nanoparticles, incorporated in a bead comprising an inorganic compound or an organic polymer, and a surface of the beads is modified with a biomolecule detection molecule.

2. The biomolecule detection reagent described in claim 1,
wherein the semiconductor nanoparticles can emit fluorescent light having different wavelengths depending on a different particle size.

3. The biomolecule detection reagent described in claim 1,
wherein the semiconductor nanoparticles are comprised of at least two kinds of semiconductor nanoparticles, being able to emit fluorescent light having different wavelength.

4. The biomolecule detection reagent described in claim 1,
wherein the semiconductor nanoparticles can emit fluorescent light having different wavelengths depending on a different particle size, and incorporate at least two kinds of semiconductor nanoparticles.

5. A method for detecting a biomolecule comprising the step of:
employing a biomolecule detection reagent described in claim 1.

6. The method for detecting a biomolecule described in claim 5,
wherein a semiconductor nanoparticle complex, a surface being modified with a biomolecule-detection molecule having a different particle size from that of the semiconductor nanoparticle incorporated into a bead, is further employed in combination with the biomolecule detection reagent.

7. A method for detecting a biomolecule comprising the step of:
employing the biomolecule detection reagent described in claim 4,
wherein the method is carried out on a microarray.
